(19) United States
(12) Patent Application Publication
(10) Pub. No.: US 2010/0083977 A1
(43) Pub. Date: Apr. 8, 2010

(54) Hair Treatment Product and Method

(76) Inventors: Lorri Goddard-Clark, Los Angeles, CA (US); Shari Glazer, Pacific Palisades, CA (US)

Correspondence Address: Woods Oviatt Gilman LLP, 700 Crossroads Bldg, 2 State St., Rochester, NY, 14614, US

(21) Appl. No.: 12/246,721

(22) Filed: Oct. 7, 2008

(51) Int. Cl. A61Q 5/10; A45D 19/00; A46B 15/00; A45D 42/00; A45D 44/00; A61Q 5/08

(52) U.S. Cl. 132/208; 132/270; 132/313; 132/316; 132/317

(57) ABSTRACT

A hair coloring or highlighting application set includes a first strip of material having an adhesive allowing a user to attach the first strip to a section of hair which then hang loose while the user handles the colorant or bleach and brush. The user applies a colorant or bleach to the section of hair and overlays a second strip of material on the first strip of material. The second strip of material may by at least partly transparent and the target color may be applied to one side of the first strip of material to allow the user to easily determine when the hair section has achieved the target color.

### BACKGROUND OF THE INVENTION

The present invention generally relates to hair treatments and more particularly relates to a product and method particularly suitable for applying highlights to hair. The term “highlights” are used herein is meant in the broadest sense to include any type of product applied to hair to alter the shade thereof whether that be a new color or a different shade of the same color.

Highlighting (or lowlighting for darker shades) of hair generally involves application of a hair color or bleach to select sections of hair rather than coloring all the hair on a person's head. One known method is known as “the foil method” and involves using a strip of aluminum foil on which the selected section of hair is placed with the top of the foil placed up close to the roots of the hair. The hair color or bleach is applied to the hair with a brush with the hair becoming wetted to the foil. The foil is then usually folded over on itself while other sections of hair are treated in the same way. After the appropriate processing time, the foils are removed and the hair is washed and conditioned.

Another highlighting method is known as “the cap method” and involves pulling strands of hair through holes of a specially designed cap placed on the head. Once all the strands have been pulled through, the color or bleach is applied to the strands which are then gathered on the cap and covered with a cap during the processing time.

Yet another highlighting method is known as the “balayage method” wherein strands of hair are brushed with color or bleach with a paddle supporting the strands of hair while the color is applied with a brush. The hair strands with color are then allowed to hang loose while processing.

While each of the above products and methods afford a technique for applying highlights to hair, there remains a need for a product and method for applying highlights to hair which can be performed more easily and is particularly adapted to carrying out by oneself at home, for example.

### SUMMARY OF THE INVENTION

The present invention addresses the above need by providing in a first aspect a product for applying highlights to hair. The product comprises a foil in strip form which includes an adhesive applied along one of the short edges thereof. It is understood that although the strip is described herein as being a foil, other suitable materials, either flexible or rigid, may be used as desired. The adhesive is covered with a removable cover sheet to protect the adhesive prior to use.

A second strip of material, preferably but not necessarily transparent, is provided which is substantially the same size and shape as the foil strip. A stack of paired foil/transparencies may be provided in a single package or in a kit which may include the colorant and other items as desired for a consumer to use to highlight their hair at home. The kit may include one or more of an applicator brush, a mixing bowl or other container, a cape, towel and a mirror, for example. Any other desired hair products such as shampoo, conditioner, hair brush, appliance (e.g., dryer/curling iron/straightener) may also be included in the kit, if desired.

It is well known that prior to application, the color of the colorant or bleach does not match the color the hair will ultimately look like once it has processed the colorant/bleach. It is also known that the processing time, i.e., the amount of time the hair is allowed to sit with the colorant/bleach thereon, affects the final hair color. For example, the longer the processing time, the lighter the hair may become when using a bleach and vice versa for non-bleach or dark shades of colorant. To facilitate obtaining the right processing time for the target color, the first and/or second strip of material may be made of or have the target color applied to all or at least a part thereof. For example, a small section of the first strip may include the target color such that the person may periodically check their section of hair that is processing to the target color on the strip until they match at which time the strips are removed and the hair is washed.

In another aspect, the invention provides a method of applying highlights to hair comprising the steps of:

a) selecting and separating a section of hair from the remaining hair on a person's head;

b) providing a first strip of material having an adhesive along a short edge thereof;

c) positioning the first strip of material underneath the section of hair with the adhesive pressed against the section of hair proximate the hair roots; and

d) applying a colorant or bleach to the section of hair and thereby wetting the section of hair to the strip of material.

The method may further comprise the step of applying a second strip of material over the section of hair on the first strip of material and allowing the hair to process the colorant or bleach. The second strip of material may be entirely or partly transparent.

The method may comprise the further step of applying the target hair color to the first or second strip of material to allow the person to periodically check the processing hair section against the target color on the strip until they match.

### BRIEF DESCRIPTION OF THE DRAWING FIGURES

FIG. 1 is a plan view of the first strip of material;

FIG. 2 is a perspective view of the first strip of material and second strip of material in spaced relation to the first strip;

FIG. 3 is a perspective view of a person during the application of the colorant to a section of hair on the first strip of material;

FIG. 4 is the view of FIG. 3 showing the colorant applied to the section of hair and the second strip of material applied thereover;

FIG. 5 is a perspective view of one possible kit having a stack of the paired material strips with an applicator brush, bowl, colorant and bleach packet; and

FIG. 6 is the view of FIG. 2 showing an alternate embodiment of the second strip.

### DETAILED DESCRIPTION

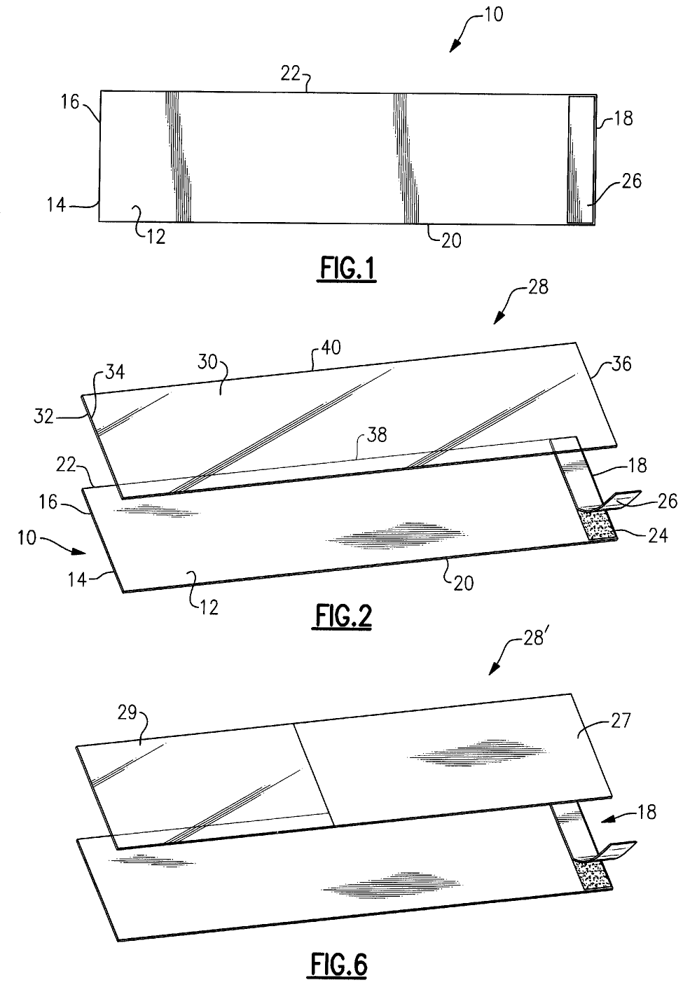

Referring now to the drawing figures, there is seen in FIGS. 1 and 2 a first strip of material 10 having opposite first and second surfaces 12, 14. In the preferred embodiment, first strip of material 10 is a flexible sheet of foil although it is understood that other flexible or rigid materials may be used as desired. It is also preferred that first strip of material 10 has a substantially rectangular shape as shown with opposite short edges 16,18 and opposite long edges 20,22 although it is again understood that any shape may be used as desired.

An adhesive strip 24 is applied on strip 10 adjacent one of the short edges 18 thereof. A releasable cover sheet 26 is positioned over the adhesive strip 24 to protect the integrity of the adhesive prior to use. The adhesive strip may form one continuous strip or be a series of one or more adhesive spots or strips. The type of adhesive used should be of a type that will stick to hair yet be easily removed with substantially no adhesive transferring to the hair.

A second strip of material 28 is seen in FIGS. 2 and 4 and includes opposite surfaces 30,32. In the preferred embodiment, second strip of material 28 is a transparent sheet of flexible plastic in substantially the same shape and size as first strip of material 10 although it is understood that other transparent, partly transparent or non-transparent, flexible or rigid materials may be used as desired. For example, a second strip of material 28′ is seen in FIG. 6 having both a non-transparent section 27 and transparent section 29. The transparency allows a user to check the color of the hair being processed without having to lift the second strip of material. Thus, in the preferred embodiment shown in the drawing, second strip of material 28 includes opposite short edges 34,36 and opposite long edges 38,40 although it is understood that any shape and size either the same or different than first strip of material 10 may be used as desired.

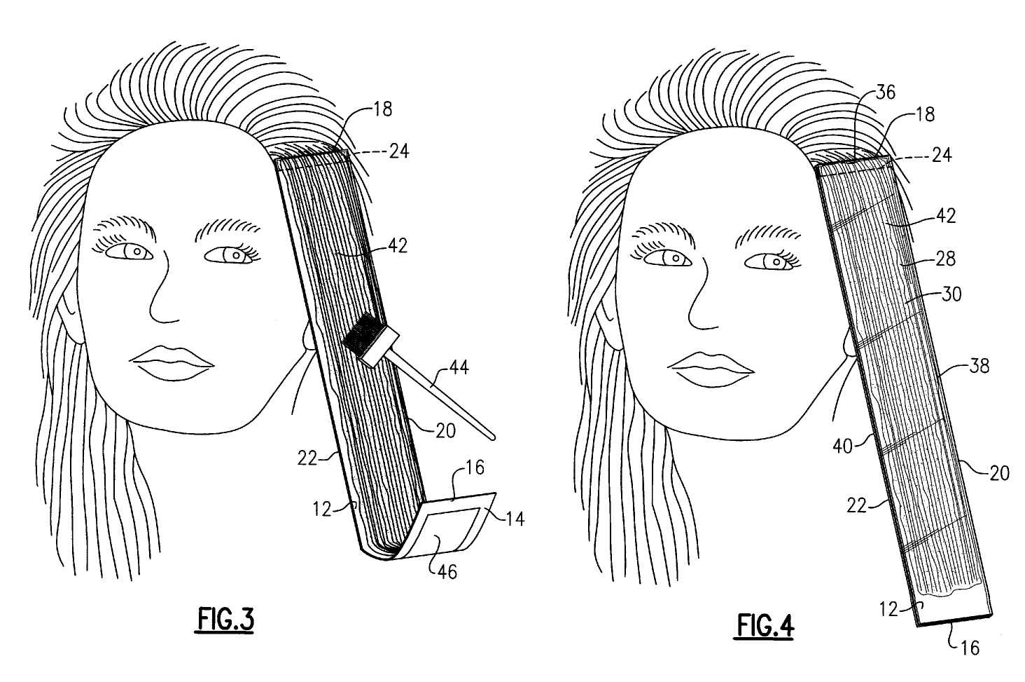

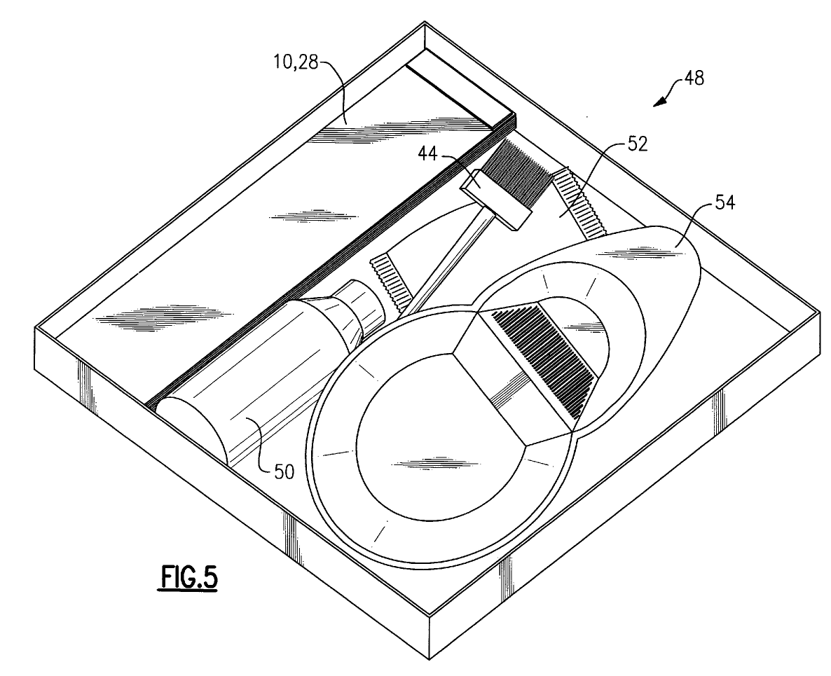

Referring now to FIG. 3, first strip of material 10 is applied to a selected section of hair 42 by placing the edge 18 close to the head or roots of the hair section with the adhesive strip 24 pressed under and against the hair section. The length of the hair section 42 is then directed over the material surface 12 as shown. As seen in FIGS. 4 and 5, it is preferred that first strip of material 10 is of a length which is the same as or slightly longer than the section of hair with which the strip will be used. In this regard, the first strip of material 10 may be offered to the customer in a series of different lengths or it may be provided in very long lengths that the customer may then cut to the length required for their hair.

It will be appreciated that, due to the adhesive 24 sticking to the hair, the strip 10 will remain in place until manually pulled off the hair. This is advantageous in that this frees the person's hands which facilitates the colorant or bleach application process. Once the first strip of material 10 is in place, either the person doing their own hair or a second person applies the colorant or bleach to the hair section 42 with an applicator brush 44. Once the colorant or bleach has been properly applied to the hair section 42, the second strip of material 28 is applied thereover, sandwiching the hair section 42 between the first and second strips of material 10,28, respectively. The second strip of material protects the hair section during processing and it is thus preferred that the second strip of material completely cover the hair section 42 as shown in FIG. 5.

The user may repeat the above steps with additional strips of material with further selected sections of hair in any desired pattern. The hair is then allowed to process the colorant or bleach for a period of time which will vary depending on the target hair color. The colorant or bleach is usually sold showing a sample of the target hair color. The target color may be advantageously provided on either or both of the first and second strips of material 10,28. In the preferred embodiment seen in FIG. 3, a sample patch 46 of the target color is provided on first strip of material 10 on the surface 14 opposite surface 12 on which the hair section 42 rests. The person may thus periodically check and compare the hair section against the target color patch 46 by placing them side-by-side until they match, at which time the person knows it is time to stop the color or bleach processing and remove the material strips from the hair. This is done by first removing the second strip of material 28 and then gently releasing the adhesive from the hair at which time the first strip of material may be easily separated from the hair section to which it was attached. The hair may then be rinsed and neutralized to remove the excess colorant or bleach and styled as desired.

FIG. 5 shows an example of a kit 48 which may include a stack of paired material strips 10,28 and one or more of additional hair treatment items such as applicator brush 44, colorant 50, bleach packet 52 and mixing bowl 54 to mix the colorant or bleach powder, for example. Although not shown, any other desired items may be provided in the kit such as, for example, a cape, towel, mirror, hair brush, comb, hair dryer, curling iron, hair straightener, shampoo and conditioner.

While the invention has been shown and described in accordance with preferred embodiments thereof, it is understood that modifications may be made thereto without departing from the full spirit and scope of the invention as defined by the claims which follow.

1. Hair coloring or bleaching application set, comprising:
a) a first strip of material having opposite first and second edges, said first edge having an adhesive applied thereto;
b) a second strip of material having opposite first and second edges and alignable with said first strip first and second edges, respectively, upon positioning said second strip in covering relation over said first strip.

2. The application set of claim 1 and further comprising a color patch on said first strip of material, said color patch representing a target color for the hair with which said application set is being used.

3. The application set of claim 2 wherein said second strip of material is entirely transparent.

4. The application set of claim 2 wherein said second strip of material is partly transparent.

5. The application set of claim 1 and further comprising a paper releasably placed over said adhesive thereby protecting said adhesive prior to use.

6. A kit including the application set of claim 1 and further including one or more of a hair colorant, a bleach packet, a brush, a cape, a towel, a mirror, a hair appliance, shampoo and conditioner.

7. A method for coloring or highlighting hair, said method comprising the steps of:
a) applying a first strip of material having an adhesive to a section of hair;
b) applying colorant or bleach to the section of hair;
c) placing a second strip of material over the section of hair on the first strip of material; and
d) allowing the section of hair to process the colorant or bleach and thereafter removing the first and second strips of material from the section of hair.

8. The method of claim 7 and further comprising the step of applying a patch of a target color to said first strip of material and comparing the section of hair to the patch of target color and removing said first and seconds trips of material once the color of the hair section substantially matches the patch of target color.

9. The method of claim 8 wherein at least a part of said second strip of material is transparent.

10. A hair coloring or bleaching kit comprising:
a) a set of strips of material for applying a color or bleach to selected strands of hair;
b) a hair colorant;
c) a bleach packet;
d) a cape; and
e) shampoo and conditioner.

11. The kit of claim 10, and further comprising a brush and towel.

12. The kit of claim 11 and further comprising a mirror and a hair appliance.
